(19) United States
(12) Patent Application Publication
(10) Pub. No.: US 2011/0173757 A1
(43) Pub. Date: Jul. 21, 2011

(54) CUSHIONING DEVICES AND METHODS

(75) Inventors: Bob Rensink, Denver, CO (US); Jonathan Amendola, Denver, CO (US)

(73) Assignee: Denver Mattress Co. LLC, Denver, CO (US)

(21) Appl. No.: 13/041,228

(22) Filed: Mar. 4, 2011

Related U.S. Application Data
(63) Continuation-in-part of application No. 12/874,489, filed on Sep. 2, 2010.
(60) Provisional application No. 61/239,386, filed on Sep. 2, 2009.

(51) Int. Cl. B68G 5/00; A47C 23/04; A47C 27/14

(52) U.S. Cl. 5/698; 5/655.5; 5/690

(57) ABSTRACT

A cushion may be constructed of a spacer material having a top layer, a bottom layer and a plurality of loosely arranged spacer elements that extend between the top and bottom layers so as to maintain the top layer and the bottom layer spaced apart from each other. An elastomeric gel material is incorporated into the top layer and/or the bottom layer. The gel material may also extend into at least a portion of the spacer elements.

### CROSS REFERENCES TO RELATED APPLICATIONS

This application is a continuation-in-part of U.S. application Ser. No. 12/874,489, filed Sep. 2, 2010 which claims the benefit of U.S. Provisional Application No. 61/239,386, filed Sep. 2, 2009, the complete disclosure of which is hereby incorporated by reference

This application is also related to copending U.S. application Ser. No. 12/619,286, filed Nov. 16, 2009, the complete disclosure of which is hereby incorporated by reference.

### BACKGROUND OF THE INVENTION

This invention relates generally to the field of cushions, and in particular to cushions having a spacer material that incorporates a gel. In some embodiments, such a cushion may be included as part of a mattress. Other embodiments relate to mattresses, and in particular with mattresses having various layers, including a fibrous air circulation layer (or spacer material) included with separate cushion layers.

It is becoming more common to provide cushion layers on top of a mattress core. Examples of such cushion layers include foam materials, such as visco, latex and polyurethane. However, when laminating such layers together, the glue being placed between the layers may result in a “hard spot” where the two layers are joined by the glue. Moreover, the glue prevents the layers from adequately stretching. Further, visco materials can trap heat and moisture and can feel hard to the touch when the visco material is cool. The mattresses of the invention address these and other issues.

### BRIEF SUMMARY OF THE INVENTION

In one embodiment, the invention provides a cushion that may be used in a wide variety of applications. The cushion comprises a spacer material having a top layer, a bottom layer and a plurality of loosely arranged spacer elements that extend between the top and bottom layers so as to maintain the top layer and the bottom layer spaced-apart from each other. An elastomeric gel material is incorporated into the top layer and/or the bottom layer. The gel material may also extend into at least a portion of the spacer elements.

The top and/or bottom layers may comprise a plurality of knitted fibers, woven fibers, twisted fibers or strands that are bonded or welded at spaced apart locations. The spacer elements may comprise monofilaments or yarns.

In one aspect, the gel material occupies about 5% to about 100% of the height of the spacer material. In another aspect, the gel material may comprise a silicone gel, a polyurethane gel, a polyol gel, a PVC gel, a polyorganosiloxane gel, a polyisocyanate gel, a NCO-prepolymer gel or the like. In some cases, the gel may be constructed primarily from soy.

The cushion may be used in a variety of applications, such as in a mattress, seat, pillow, operating table, or the like. When used in a mattress, the cushion may be placed on top of a core, such as a traditional spring core, individually wrapped springs, latex cores, air bladder cores and the like. Optionally, one or more padding layers may be positioned between the core and the cushion. Such padding layers may comprise those made from polyurethane, visco, latex and the like. Also, a fire retardant layer and/or a cover may be placed over the cushion. The cover may be a quilted or non-quilted fabric.

The invention also provides an exemplary method for manufacturing cushion where a spacer material is placed into a mold. The mold contains a liquid gel that becomes incorporated into the spacer material. The gel is permitted to cure and the resulting cushion is removed from the mold.

In other embodiments, the invention provides a wide variety of mattresses having various cushion layers with a fibrous air spacer layer positioned on or between at least one of the cushion layers. For example, in one embodiment a mattress is constructed of a core and cushion layer that is positioned above the core. A fibrous air spacer layer (also referred to as an air spacer layer or spacer fabric) is positioned above the cushion layer, and a layer of visco-elastic foam is positioned above the fibrous layer. In this way, the fibrous layer is sandwiched between the cushion layer and the layer of visco-elastic material. In some cases, cushion layer may comprise a polyurethane foam. Also, in certain embodiments, an air spacer layer could also be positioned between the core and the cushion layer, and the core in some cases could have a modified surface layer.

In certain embodiments, the fibrous air spacer layer may be positioned between various layers in a mattress. For instance, the fibrous air spacer layer may be positioned between layers of cushion layers, such as between two layers of viscoelastic foam. As another example, the fibrous air spacer layer may sit between two layers of latex foam, or between combinations of various foams, such a viscoelastic, latex, polyurethane and the like. As yet another example, the air spacer layer could sit atop essentially any type of firm core (spring, foam, latex or the like) and a topper layer (which may comprise any type of cushioning material configured to loosely rest on the core). In other embodiments, the layers between which the fibrous air spacer layer sits could have their surfaces modified (so that they are not planar). The surfaces of these layers could be altered using SMT (surface modified technology) or by profile cutting.

### BRIEF DESCRIPTION OF THE DRAWINGS

FIG. 1 is a top perspective view of one embodiment of a cushion having a spacer material and a gel according to the invention.

FIG. 2 is a bottom perspective view of the cushion of FIG. 1.

FIG. 3 is a side view of the cushion of FIG. 1.

FIG. 4 is an exploded side view of one embodiment of a mattress incorporating the cushion of FIG. 1

FIG. 5 is a perspective view of the mattress of FIG. 4.

FIG. 5A illustrates the mattress of FIG. 5 with the cushion layer inverted.

FIG. 6 illustrates a mold that may be used to construct a cushion according to the invention.

FIG. 7 is a flowchart illustrating one method for constructing a cushion.

FIG. 8 is a top perspective view of an alternative embodiment of a cushion according to the invention.

FIG. 9 is a bottom perspective view of the cushion of FIG. 8.

FIG. 10 illustrates a perspective view of one embodiment of a fibrous air spacer layer according to the invention.

FIG. 11 is a side view of the fibrous air spacer layer of FIG. 1

FIG. 12 is an exploded perspective view of one embodiment of a mattress having a fibrous air spacer layer according to the invention.

### DETAILED DESCRIPTION OF THE SPECIFIC EMBODIMENTS

In certain embodiments, the invention describes various cushions that may be used in a wide assortment of applications. Merely by way of example, the cushions described herein may be used as one or more layers in a bed mattress, in a topper for a mattress, a seat cushion (for chairs, couches, vehicles, boats or airplanes, and the like), padding for surgical tables, pillows, and the like. Such cushions may be constructed of a spacer material that incorporates a stable, elastomeric gel, although other materials, such as foams, can also incorporate such gels.

The spacer materials may be constructed in a variety of way, but typically include three components: a top layer, a bottom layer and spacer elements that separate the top and bottom layers. The spacer materials are constructed to be both light weight and contain loosely arranged spacer elements that permit circulation through the spacer material. At the same time, the spacer material is firm enough to support the weight of a human, with sufficient resiliency so as to not interfere with blood flow when resting on the spacer material. The top and bottom layers are included to provide a stabilizing structure for the spacer elements. As such, these layers can also be breathable, and in many cases contain minimal structure, such as strands, string, twisted fibers or the like that are coupled or welded together at spaced apart locations to form an open matrix, such as a honey comb or other open structure. In some cases, the top and bottom layers could also be a woven fabric or other type of light weight breathable fabric. Also, the top layer and the bottom layer could be constructed different from each other, such as by one having a tighter pattern.

The spacer elements may be single strands or fibers that extend perpendicularly between the top and bottom layers, although in some cases they could be multiple fibers twisted or joined together, sometimes referred to as a yarn. Also, the spacer elements could be angled between the top and bottom layers or could form a loosely tangled arrangement or matrix of fibers. In one specific example, the spacer elements may comprise pile monofilaments and the top and bottom layers are a knitted material. Such materials may be manufactured by Mueller Textile of Wiehl, Germany. The thickness of the spacer material may be varied depending on the particular application, but could range from 2 mm to 10 cm. Also, in some cases, multiple spacer materials could be staked on each other. The spacer materials may have zones with different stiffnesses so that different parts of the cushion will have varying stiffness values. For example, in a mattress, a zone located near the lower back could have an increased stiffness.

The gel material that is incorporated into the spacer material may be any dimensionally stable elastomeric gel. Such gels may be placed in liquid phase to permit them to be incorporated within the spacer material. Then gels are then permitted to turn to a solid state where they adhere to the spacer material. Also, the cured gel may feel elastic to the touch. The elastomeric gel may comprise a cross linked gel that retains its shape and easily bonds to the spacer material or other types of materials, such as foam materials. The elastomeric gel may be constructed from a polyurethane material, and in some cases may be constructed from about 60% or more of soy. The gel material only slightly deforms under a force, such as a user's body weight, and nearly immediately returns to its original shape after removal of the force. For example, the gel may be a soy based, cross-linked, viscous elastomer that maintains high viscous properties while remaining soft, with a Shore of 00 to about 16. This gel also has a Tan Delta of about 0.56 and a Young's modulus of about 11.09 psi. When in liquid form, the gel may flow, but when cured is a soft, resilient gelatinous material that is extremely tough. It is also somewhat tacky, and a thin sheet may be placed over the gel to remove the tacky feel.

One example of a polyurethane gel is available from Polymer Concepts, Inc. of Mentor, Ohio. Another is a soy based gel from Impact Gel Corp of West Salem, Wis. Other types of gels include PVC gels, silicone gels, NCO-prepolymer gels, polyorganos: loxane gels, polyisocyanate gels and the like.

The gels may be incorporated into the spacer materials in a variety of ways. For example, the gels may occupy only a portion of the space occupied by the spacer material. For instance, the gel could barely cover the top layer, the bottom layer or both (with no gel between them.) Or, the gel could form a layer between the top layer and the bottom layer. As a further example, the gel could occupy discrete locations or regions, either within the layers or within the spacer elements. In some cases, they could for a regular pattern, such as a honey comb or checkered pattern on one of the layers. Or, the gel could have holes for enhancing air circulation. As another example, the gel regions could be washer shaped.

In many cases, the gel will occupy either the top layer or the bottom layer and extend a certain distance between the two layers. For example, the gel could form from about 1% to about 100% of the thickness of the spacer material, and in many cases will be less than 50% of the spacer material.

Use of a gel in such a manner provides a variety of features. For example, the gel provides a comfort layer that feels soft to lay on, due to its elastic deformation. Further, by using the air spacer material, the cushion has extra “give” that helps to maintain blood flow when resting against the cushion. Further, because the gel material is relatively dense and heavy, a minimal amount can be used while still keeping the cushion relatively light weight while maintaining the comfort provided by the gel. Also, one significant benefit of the spacer material is that it permits air circulation, thus helping to regulate the temperature of the cushion while in use. Any heat that may tend to be trapped by the gel material can be transferred away from the user by air circulating through the spacer material. However, the gel material tends to trap less heat than visco materials and thus maintains a more constant temperature. Further, the gel materials do not need to be heated in order to loosen and conform to the person's body as do visco foams.

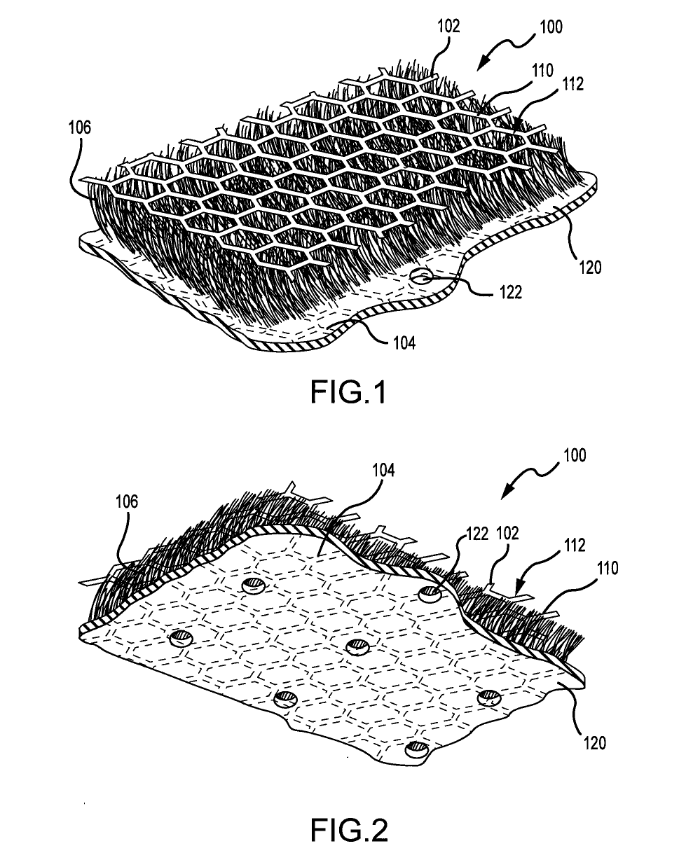

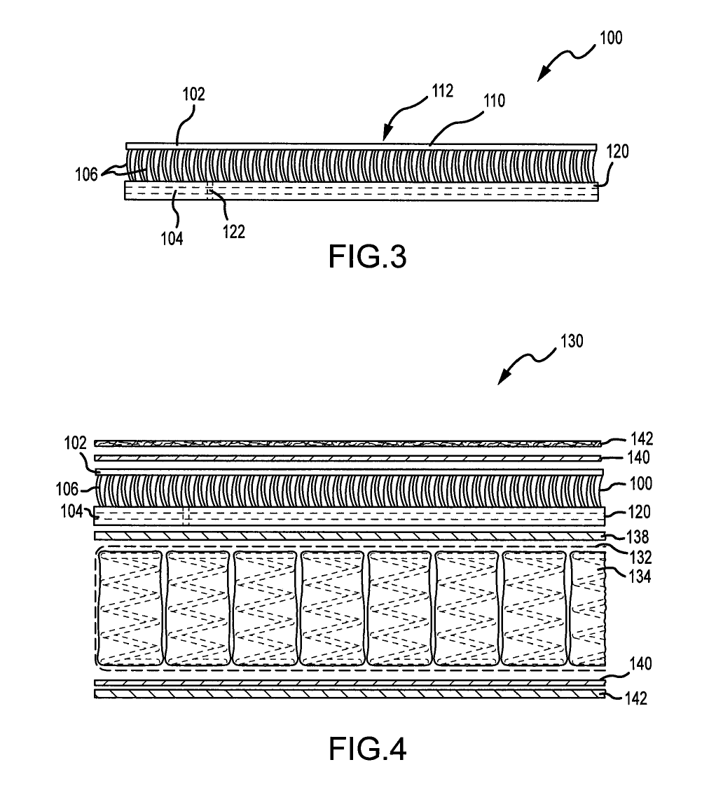

Referring now to FIGS. 1-3, one embodiment of a cushion 100 will be described. Cushion 100 comprises a top layer 102, a bottom layer 104 and spacer elements 106. Top layer 102 and/or bottom layer 104 may be constructed of twisted stands of polymers that form strings 110 that are bonded or welded together at spaced apart locations to form a support layer for the spacer elements 106. In this way, top layer 102 and bottom layer 104 comprise connected strings 110 with multiple open regions 112 to permit circulation through the layers while also providing sufficient structure to support the spacer elements 106. The spacer elements 106 comprise individual polymer filaments that extend between top layer 102 and bottom layer 104. The density and size of the filaments can vary depending on the desired stiffness and support requirements. The distance between top layer 102 and bottom layer 104 can vary, but for use in mattresses can be about 2 mm to 10 cm.

Incorporated into bottom layer 104 is a gel material 120. Gel material 120 comprises a dimensionally stable gel with an elastic feel. Gel material 120 completely surrounds and incorporates bottom layer 104 somewhat akin to a composite material. Gel material 120 extends part way between top layer 102 and bottom layer 104. As shown, gel material extends approximately one-third of the thickness of the cushion, entirely incorporating the spacer elements 106 to that thickness. Optionally, gel material 120 can include one or more through holes 122 to improved circulation through the cushion.

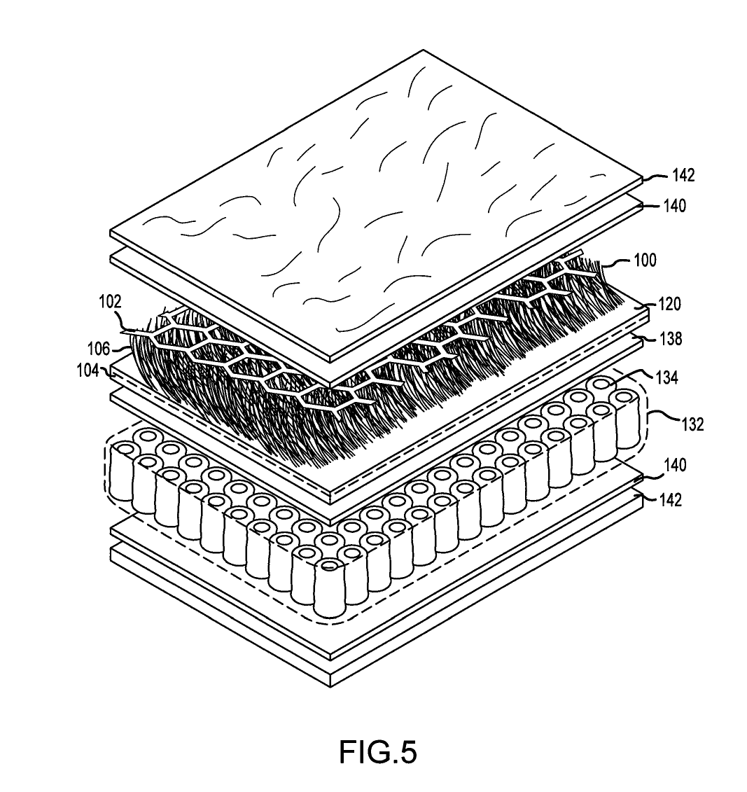

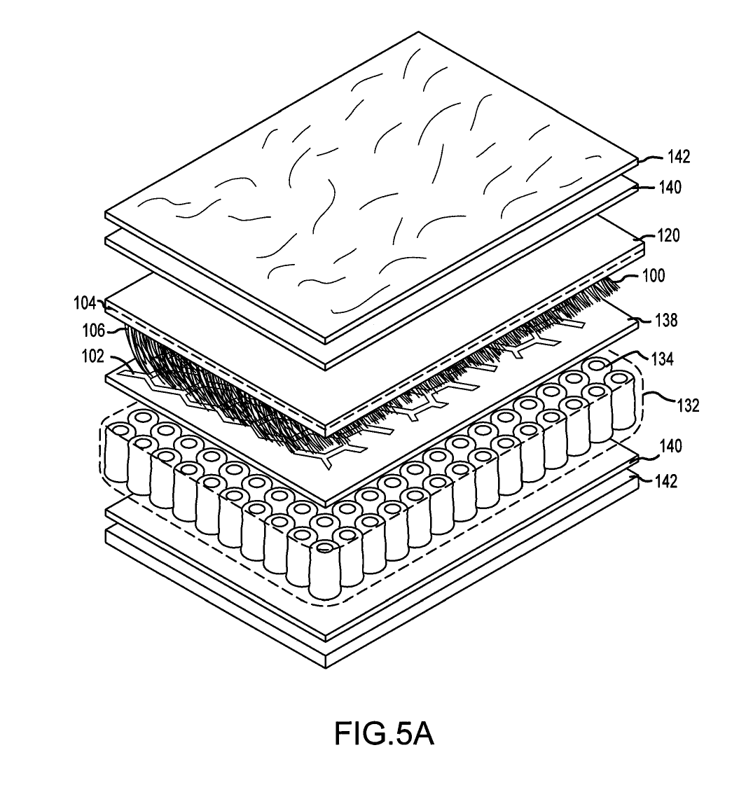

Referring now to FIGS. 4 and 5, one embodiment of mattress 130 will be described. Mattress 130 includes cushion 100 of FIGS. 1-3 and for convenience of discussion will use the same reference numerals. Although cushion 100 is shown in a mattress, it will be appreciated that cushion 100 may be used in any of the applications described herein. Mattress 130 includes a core 132. For convenience of illustration, core 132 includes an array of individually wrapped coil springs 134. However, it will be appreciated that any of the cores described herein may be used, including spring cores, latex cores, air bladders and the like. Above core 132 may be one or more padding layers 138. Layer 138 is optional and may be omitted. Further, layer 138 may be constructed using any of the padding materials described herein, including polyurethane foam, visco foam, latex and the like.

Positioned above padding layer 138 is cushion 100. Cushion 100 may be loosely placed on top of padding layer 138 or may be bonded or otherwise secured to it. In some cases, a gel material could be used to couple the two layers together. Also, although shown with bottom layer 104 closest to core 132, it will be appreciated that cushion 100 could be flipped so that top layer 102 is closest core 132. In this way, the gel material is closer to the user when laying on the mattress. Such an example is illustrated in FIG. 5A. Also, in some cases, cushion 100 could form the “pillow top” of mattress 130. Surrounding the internal components of mattress 130 (or simply placed on top and bottom) is a fire retardant or resistant layer 140. This layer is optional. Fire resistant layer 140 may be constructed of flame resistant material such as polyester binder fibers, KEVLAR™, and the like.

A fabric cover 140 may be used to finish mattress 130. Cover 140 may be either quilted or non-quilted. One advantage of using a non-quilted cover is that the user can be closer to cushion 100 to obtain the benefits of cushion 100 as described herein.

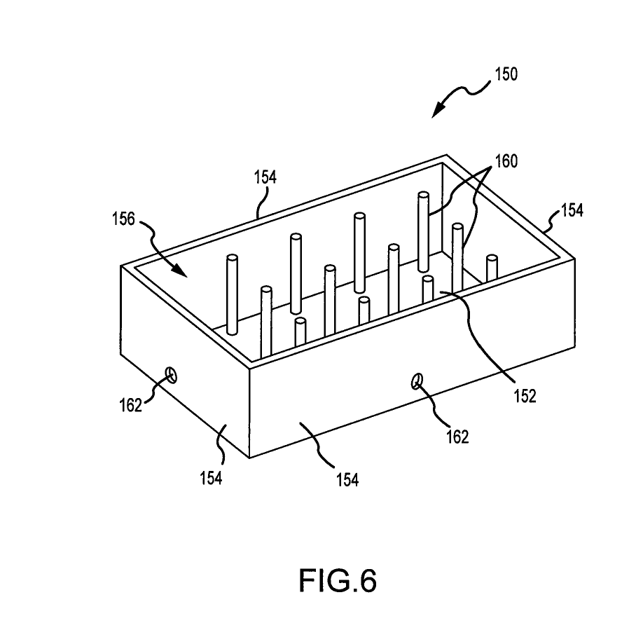

FIG. 6 illustrates a mold 150 that may be used when constructing the cushions described herein, including cushion 100. Mold 150 has a bottom 152 and sides 154 that form a cavity 156 for receiving a spacer material. Optionally, multiple posts 160 may extend upward from bottom 152 and may be used to form through holes in a gel material.

In use, an air spacer material is placed in cavity 156, with posts 160 extending through the spacer material. Cavity 156 may be sized to be approximately the same size as the outer periphery of the spacer material to reduce the amount of gel material that needs to be trimmed from the resulting cushion.

A gel material is introduced into cavity 156. This may be done before inserting the spacer material or after. If after, the liquid gel may be poured around the edges of the spacer materials or introduced through one or more holes 162. Once the liquid gel is at the desired height, the gel material is permitted to cure. In some cases, pressure may be applied to the top of the spacer material to ensure the gel material is able to be incorporated into the spacer material. Following curing, the resulting cushion is removed from mold 150 and cut and trimmed as appropriate.

It will be appreciated that the process described in FIG. 6 could be modified to be a continuous manufacturing process. For example, a conveyor belt could be configured to receive and hold a volume of liquid gel, and the spacer material could be laid down onto the conveyor as the belt moves. In this way, a continuous cushion layer may be formed. A cutter could be used to cut the cushion to any desired length.

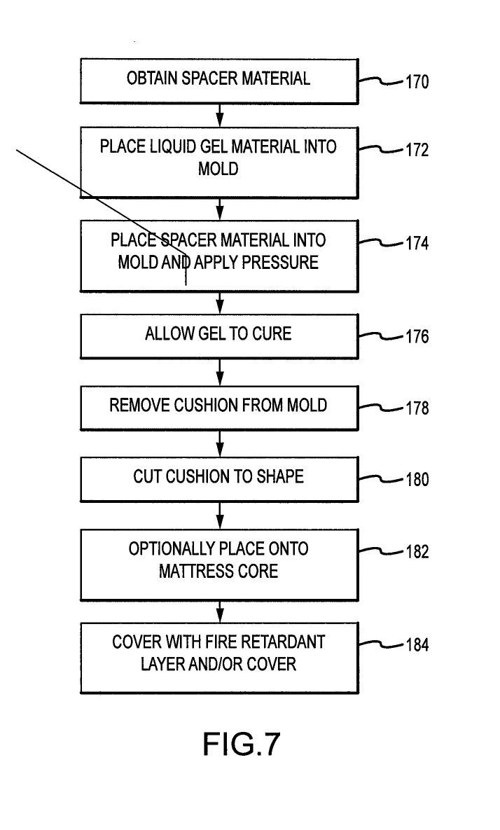

FIG. 7 illustrates one method for forming a cushion, such as cushion 100. The method utilizes a spacer material as shown in step 170 that may be any of the spacer materials described herein. A liquid gel is placed into a mold as shown in step 172, and the spacer material is placed into the mold. Pressure may be applied to the spacer material as shown in step 174. In step 176 the gel is allowed to cure, and the cushion is removed from the mold as shown in step 178. The cushion may be cut to shape (step 180) and then used in any application. As shown in step 182, the cushion may be incorporated into a mattress, such as on top of the mattress core. A fire resisting layer and cover may be used to finish the mattress as shown in step 184.

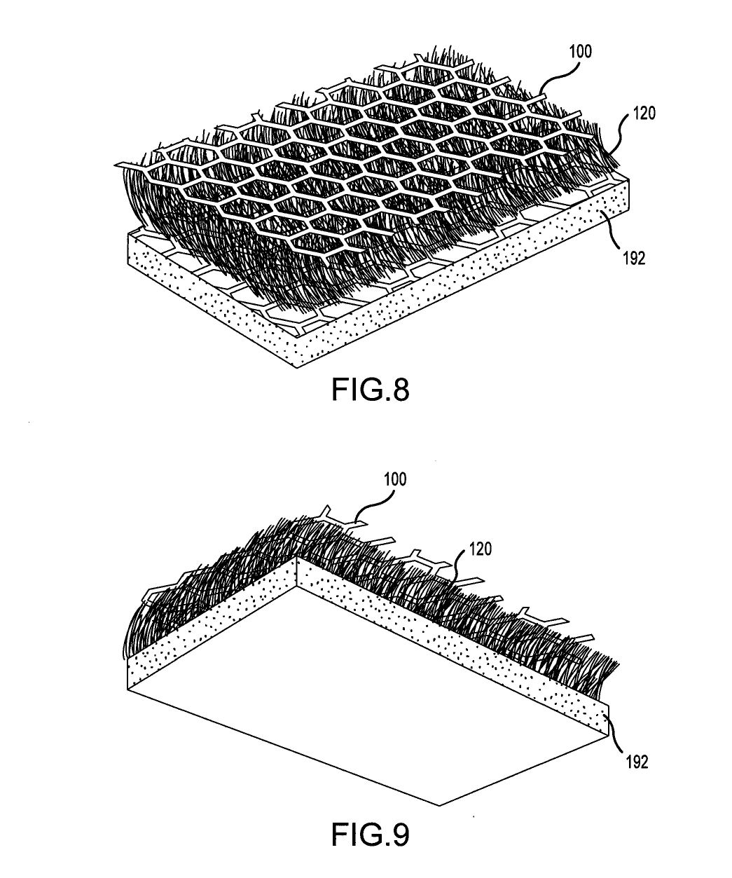

FIGS. 8 and 9 illustrate another embodiment of a cushion 190. Cushion 190 is similar to cushion 100 except that cushion 190 also includes a padding layer 192. For convenience of discussion, cushion 190 will use the same reference numerals used in connection with similar elements of cushion 100. Padding layer 192 comprises a piece of polyurethane foam and is bonded to cushion 100 by gel material 120 that permeates the top surface of the polyurethane foam to form a strong bond. Other materials that may be used for padding layer 192 include other foam materials, coils, latex, gels, air bladders, other spacer materials (with or without gels), fabrics and the like.

The invention in other embodiments provides a wide variety of mattresses that may be constructed of a variety of materials. The mattresses may be constructed of a wide variety of cores, such as box spring cores, individually wrapped spring cores, spring steel cores, latex rubber cores, air cores, gel cores, and the like. However, it will be appreciated that the invention is not limited to the specific type of core that is used, but rather on the layers that are positioned above or beneath such a core. Also, it will be appreciated that in some cases a core may not be needed and the various cushion layers as described herein may provide adequate cushioning to function as a mattress or support layer for a user. In most applications, the mattress will be a typical bed mattress that is long and wide enough to support a user while sleeping. However, it will be appreciated that the principles of the invention may be used with other types of cushioning, such as seat cushions, couches, chairs, and the like.

Positioned above or beneath the core are one or more cushion layers which provide additional comfort to the user. Examples of such layers are visco-elastic foams, latex foams, polyurethane foams, gels, coils, air, and the like. Such foam layers may have a wide variety of densities, hardnesses, indentation deflection pressures, thicknesses and the like. However, for visco-elastic layers, the thickness will typically be in the range from about 0.5 inch to about 8 inches. For latex foams, the thicknesses will generally be in the range from about 0.5 inch to about 6 inches, and for polyurethane foams, the thickness will typically be in the range from about 0.25 inch to about 15 inches.

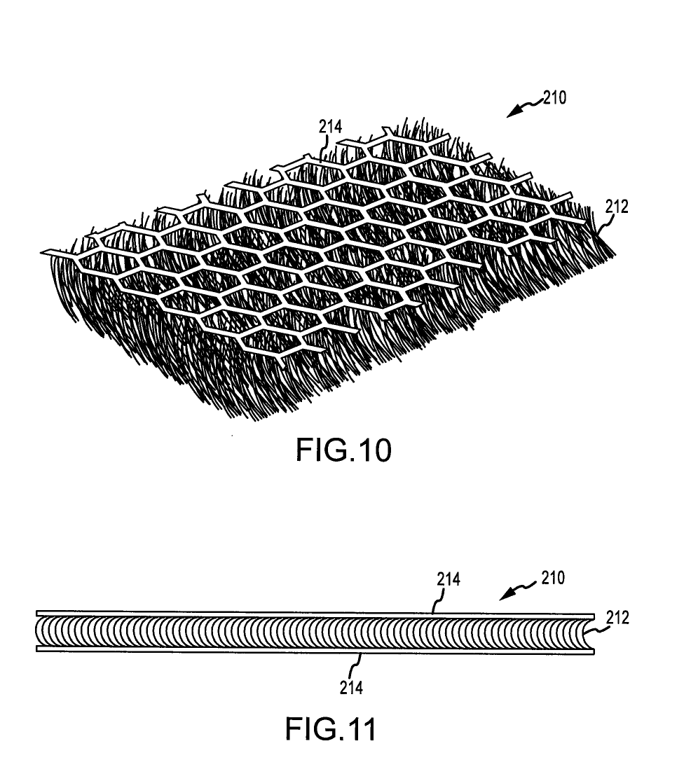

One important feature of the invention is that the fibrous air spacer layer is positioned between two of the cushion layers and/or between the cushion layer and the core. One example of a fibrous cushion layer 210 is illustrated in FIGS. 10 and 11. As shown, fibrous air spacer layer 210 is constructed of multiple strands of fibers 212 and which sit between a honey comb layer 214. The fibers are loosely arranged so that air may circulate between the fibers. Also, honey comb layer 214 provides a convenient way to bond the fibrous air spacer layer 210 between other layers. In one specific embodiment, fibrous air spacer layer 210 may be constructed of a three-dimensional spacer or polyester fabric that is constructed of two warp-knitted layers which are connected by pile mono filaments in a single knitting process. In another embodiment, fibrous air spacer layer 210 may be constructed of two covering layers that are held apart from each other by a pile layer. In turn, the pile layer is made up of pile threads which provide a degree of elasticity to the layer. A textile construction process is used to make the layer, with its physical properties being determined by the material used to make the pile and the thread composition. One example of spacer fabrics that can be used include the Space Air®, Flex and Space Com textiles, available from Pressless GmbH. Another type of material that can be used for layer 222 is commercially available from Mueller Textile of Wiehl, Germany. Further, one specific type of fibrous air spacer layer is described in published U.S. Application No. 2007/021705, incorporated herein by reference. Typically, fibrous air spacer layer 210 will have a thickness in the range from about 1/16 inch to about 2 inches. In certain embodiments, other fibrous materials may be used. Also, in some cases the air spacer layer 210 can be constructed to have different degrees of firmness. For example, some could be more firm while others are more plush. This helps with the overall posture of the mattress, affecting the degree how firm or how plush the mattress feels to the user. Further, different air spacer layers could be used in combination, with some being more firm while others are more plush. In some cases, air spacer layer 210 could include a gel material incorporated into part of the fibers, such as in a bottom portion of the layer. Such a gel material serves to transfer heat away from the adjacent cushion layers while also permitting airflow through the fibers in the air layer that do not have the gel. This has the benefit of using two heat transfer mechanisms to remove heat from the adjacent cushion layers. Such gel materials and methods for their incorporation herein were previously described.

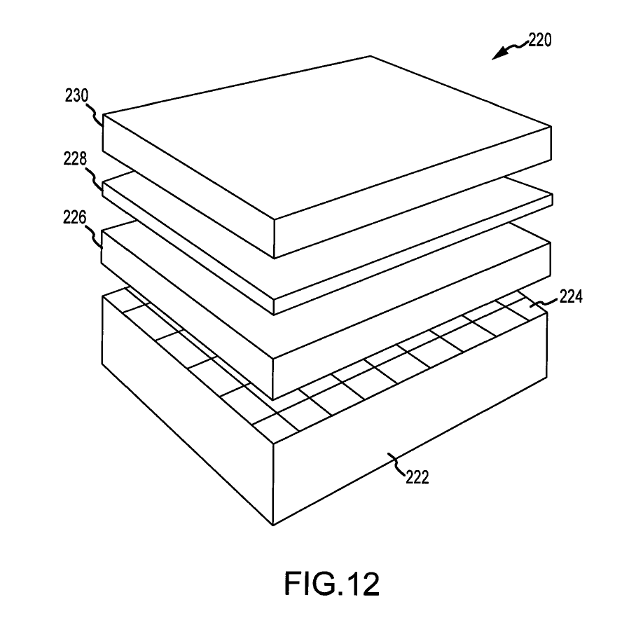

Referring now to FIG. 12, one specific embodiment of a mattress 220 will be described. Mattress 220 is constructed of a polyurethane layer 222 which may optionally have a surface modified top surface 224. This may be accomplished using a SMT process, by profile cutting and the like. Also, it will be appreciated that any of the layers of mattress 220 could be surface modified or planar or combinations thereof. Polyurethane layer 222 may be positioned on top of a core or may alternatively function as the core itself. Examples of cores to which layer 222 may be attached include traditional spring coil cores, pocket spring cores, air cores, latex cores and the like. Typically, polyurethane layer 222 will have a thickness in the range from about 1 inch to about 12 inches. Laminated to polyurethane layer 222 is a visco layer 226 which may have a thickness in the range from about 0.5 inch to about 4 inches and may optionally have a surface modification. Laminated to visco layer 226 is a fibrous air spacer layer 228. Optionally, or in addition to, an air spacer layer may be placed between layers 222 and 226. Finally, laminated to air spacer layer 228 is another visco layer 230. Air spacer layer 228 will typically have a thickness in the range from about 1/16 inch to about 2 inches, and visco layer 230 will have a thickness in the range from about 0.5 inch to about 3 inches.

While one specific embodiment has been described in connection with FIG. 12, it will be appreciated that fibrous air spacer layer 228 could be placed in other locations as well, such as between polyurethane layer 222 and visco layer 226. Also, each of the cushion layers in FIG. 12 could also be made of different materials. For example, polyurethane layer 222 could be constructed of latex, visco, a gel, an inflatable bladder, or the like. Similarly, visco layers 226 and/or 230 could be constructed on a polyurethane, latex, gel, an inflatable bladder, or the like. Hence, in one arrangement, layers 222 and 226 could both be made of latex, with air spacer layer 228 positioned between them. Further, some of these layers could be eliminated, such as layer 222. As another example, layers 222 and 226 could be used, with layer 228 placed between them, and with layer 230 being eliminated. In other cases, air spacer layer 228 could be placed between the core and a topper layer. This topper layer is loosely held on top of a firm core and may comprise one or more layers of padding materials. In some cases, the air spacer layer 228 could also be included in the topper layer itself.

By using fibrous air spacer layer 228, a number of significant advantages are achieved. First, by using fibrous air spacer layer 228, improved air circulation is provided between the various layers. With the mattress of FIG. 12, air circulation is provided between the two visco layers 226 and 228. However, as previously described, air circulation could be provided between other layers, such as between a visco layer, latex layer and/or polyurethane foam layers. This provides for a more hygienic and comfortable sleeping environment.

Another significant advantage is that air spacer layer 228 provides improved heat dissipation through and around the various cushion layers, including layers 222, 226 and 230. This also provides for a more hygienic and comfortable sleeping environment. Fibrous air spacer layer is particularly useful when placed adjacent one of the visco layers as the visco foam material tends to trap the user's body heat. By providing air circulation beneath the other surface of the visco layer, heat is able to travel through the visco foam and to be dissipated from the other surface, thereby providing a cooler sleeping environment.

Another feature is that moisture transported and dissipated through the layers is increased, leading to a more sanitary and hygienic sleeping environment.

Further, because most laminating methods involve gluing multiple layers of foams, viscose and latex together in the cushion or support layers, “hard spots” result where the two layers are joined together. This is uncomfortable for the user and also prevents the layers from stretching. By gluing the various comfort or support layers to fibrous air spacer layer 228, fibrous air spacer layer 228 functions as a stretchable spacer fabric and also eliminates the hard spot where the foams would normally be attached to each other. Because fibrous air spacer layer 228 is stretchable, it functions as a stretchable spacer fabric to allow the layers to be more pliable.

The invention has now been described in detail for purposes of clarity and understanding. However, it will be appreciated that certain changes and modifications may be practiced within the scope of the appended claims.

What is claimed is:

1. A cushion comprising:
a spacer material comprising a top layer, a bottom layer and a plurality of loosely arranged spacer elements that extend between the top layer and the bottom layer so as to maintain the top layer and the bottom layer spaced apart from each other; and
an elastomeric gel material incorporated into at least one of the top layer or the bottom layer and into at least a portion of the spacer elements.

2. A cushion as in claim 1, wherein at least one of the top layer or the bottom layer comprises at least one of a plurality of knitted fibers, a plurality of woven fibers, a plurality of twisted fibers, or a plurality of strands that are bonded or welded at spaced apart locations.

3. A cushion as in claim 1, wherein the spacer elements comprise monofilaments.

4. A cushion as in claim 1, wherein the spacer material has a thickness between the top layer and the bottom layer, and wherein the gel material is formed as a layer that occupies about 5% to about 100% of the thickness.

5. A cushion as in claim 1, wherein the gel material comprises a dimensionally stable gel that is constructed of a material selected from the group consisting of silicone gels, polyurethane gels, polyol gels, PVC gels, polyorganosiloxane gels, polyisocyanate gels, NCO-prepolymer gels.

6. A cushion as in claim 5, wherein the gel material comprises at least 60% soy.

7. A cushion as in claim 1, further comprising a cushion layer operably coupled to the air spacer material, wherein the cushion layer is selected from a group consisting of a polyurethane foam, latex and a viscoelastic foam.

8. A cushion as in claim 1, further comprising a core operably coupled to the air spacer material, wherein the core is selected from a group consisting of spring coil cores, individually wrapped spring cores, latex cores, and air cores.

9. A mattress comprising:
a core;
a cushion layer positioned above the core, wherein the cushion layer comprises:
a spacer material comprising a top layer, a bottom layer and a plurality of loosely arranged spacer elements that extend between the top layer and the bottom layer so as to maintain the top layer and the bottom layer spaced apart from each other; and
an elastomeric gel material incorporated into at least one of the top layer or the bottom layer and into at least a portion of the spacer elements.

10. A mattress as in claim 9, wherein at least one of the top layer or the bottom layer comprises at least one of a plurality of knitted fibers, a plurality of woven fibers, a plurality of twisted fibers, or a plurality of strands that are bonded or welded at spaced apart locations.

11. A mattress as in claim 9, wherein the spacer elements comprise monofilaments.

12. A mattress as in claim 9, wherein the spacer material has a thickness between the top layer and the bottom layer, and wherein the gel material is formed as a layer that occupies about 5% to about 100% of the thickness.

13. A mattress as in claim 9, wherein the gel material comprises a dimensionally stable gel that is constructed of a material selected from the group consisting of silicone gels, polyurethane gels, polyol gels, PVC gels, polyorganosiloxane gels, polyisocyanate gels, NCO-prepolymer gels.

14. A mattress as in claim 13, wherein the gel material comprises at least 60% soy.

15. A mattress as in claim 9, further comprising at least one other cushion layer positioned between the spacer material and the core.

16. A mattress as in claim 9, further comprising a cover positioned above the cushion layer, wherein the cover is selected from a group consisting of quilted covers, non-quilted covers and fire resistant covers.

17. A method for constructing a cushion, the method comprising:
providing a spacer material comprising a top layer, a bottom layer and a plurality of loosely arranged spacer elements that extend between the top layer and the bottom layer so as to maintain the top layer and the bottom layer spaced apart from each other;
placing the spacer material into mold;
introducing a gel material into the mold, wherein the gel material is sufficiently viscous to permit the gel material to become incorporated into the bottom layer and at least a portion of the spacer elements;
permitting the gel material to solidify sufficient to become elastic and dimensionally stable; and
removing the spacer material from the mold.

18. A method as in claim 17, wherein the mold includes a plurality of columns, and wherein the spacer material is inserted over the columns.

19. A method as in claim 17, wherein the gel material is introduced such that it reaches a height of at least about 5% of a height of the spacer material.

20. A method as in claim 17, wherein at least one of the top layer or the bottom layer comprises at least one of a plurality of knitted fibers, a plurality of woven fibers, a plurality of twisted fibers, or a plurality of strands that are bonded or welded at spaced apart locations, and wherein the gel material comprises a dimensionally stable gel that is constructed of a material selected from the group consisting of silicone gels, polyurethane gels, polyol gels, PVC gels, polyorganosiloxane gels, polyisocyanate gels, NCO-prepolymer gels.
